(19) United States
(12) Patent Application Publication
(10) Pub. No.: US 2013/0105520 A1
(43) Pub. Date: May 2, 2013

(54) BATTER DISPENSER AND METHOD FOR USING SAME

(71) Applicants: Thomas Barber, Redondo Beach, CA (US); Bryce Butcher Altounian, Monrovia, CA (US)

(72) Inventors: Thomas Barber, Redondo Beach, CA (US); Bryce Butcher Altounian, Monrovia, CA (US)

(21) Appl. No.: 13/287,904

(22) Filed: Nov. 2, 2011

(51) Int. Cl. B67D 7/56; B65D 37/00

(52) U.S. Cl. 222/154; 222/206; 222/562

(57) ABSTRACT

A batter dispenser and a method of using the batter dispenser are provided. The batter dispenser includes a lower body, an upper body detachably connected to the lower body, and a dispenser member detachably connected to the upper body, the dispenser member including a first nozzle configured to control the flow of batter therethrough. The method includes placing a dry-mix ingredient of a batter into the lower body, adding a liquid ingredient of the batter to the dry-mix ingredients, assembling the batter dispenser by connecting the lower body, the upper body, and the dispensing member, shaking the batter dispenser to mix the dry-mix ingredient and the liquid ingredient to form the batter, and squeezing the upper body to cause batter to flow out of batter dispenser.

### BACKGROUND OF THE INVENTION

1. Field of the Invention

The present invention is directed generally to a batter dispenser and method of using the batter dispenser and, more particularly, to a batter dispenser that allows a user to mix the batter in the batter dispenser prior to dispensing and a method for mixing and dispensing the batter in the batter dispenser.

2. Description of Related Art

Generally, in order to make pancakes, waffles, or other food products from batter, a large number of utensils are necessary. For example, in order to make pancakes, batter is formed by combining dry-mix ingredients with one or more liquid ingredients into a bowl. The ingredients are then mixed with another utensil until the batter takes on a specific consistency. After the batter is mixed, the batter is then removed from the bowl and added to a dispenser to be poured onto a griddle or other pan for cooking Generally these dispensers are not capable of storing the batter for long periods of time and therefore small amounts are used, thereby requiring constant refilling of the dispensers for large batches of batter. Because making pancakes, waffles, or other food products from batter requires multiple utensils, and may also require transferring batter from one utensil to another, cleanup may take a long time.

### BRIEF SUMMARY OF THE INVENTION

According to principles of this invention, a batter dispenser and a method for measuring, mixing and dispensing a batter for making pancakes, waffles or other similar food products is provided in a single utensil. The single utensil can also be used to make unique custom designed shapes for pancakes, waffles, or other similar food products.

According to one aspect of the present invention, a batter dispenser is provided. The batter dispenser includes a lower body, an upper body detachably connected to the lower body, and a dispenser member detachably connected to the upper body, the dispenser member including a first nozzle configured to control the flow of batter therethrough.

According to another aspect of the present invention, a method of using a batter dispenser having a lower body, an upper body detachably connected to the lower body, and a dispenser member detachably connected to the upper body is provided. The method includes placing a dry-mix ingredient of a batter into the lower body, adding a liquid ingredient of the batter to the dry-mix ingredients, assembling the batter dispenser by connecting the lower body, the upper body, and the dispensing member, shaking the batter dispenser to mix the dry-mix ingredient and the liquid ingredient to form the batter, and squeezing the upper body to cause batter to flow out of batter dispenser.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 is a side view of a batter dispenser according to an exemplary embodiment of the present invention;

FIG. 2 is an exploded side view of the batter dispenser of FIG. 1;

FIG. 3 is a partial side view of the batter dispenser of FIG. 1 with a secondary nozzle attached to the primary nozzle; and

FIG. 4 is a perspective view of the batter dispenser of FIG. 1 in use.

### DETAILED DESCRIPTION OF THE INVENTION

Reference will now be made in detail to an exemplary embodiment of the present invention, which is illustrated in the accompanying drawings.

As used in the specification, the term “substantially” is intended to allow for manufacturing tolerances and other minor deviations.

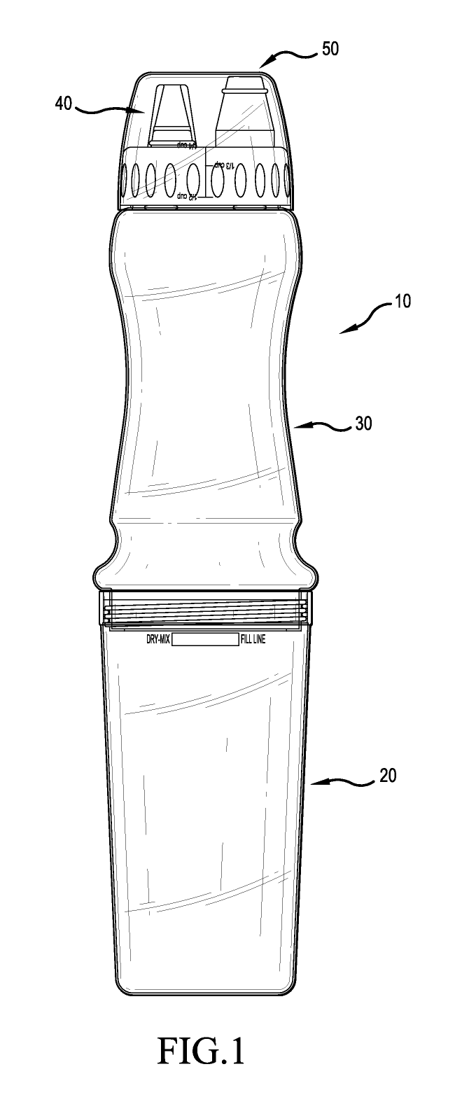

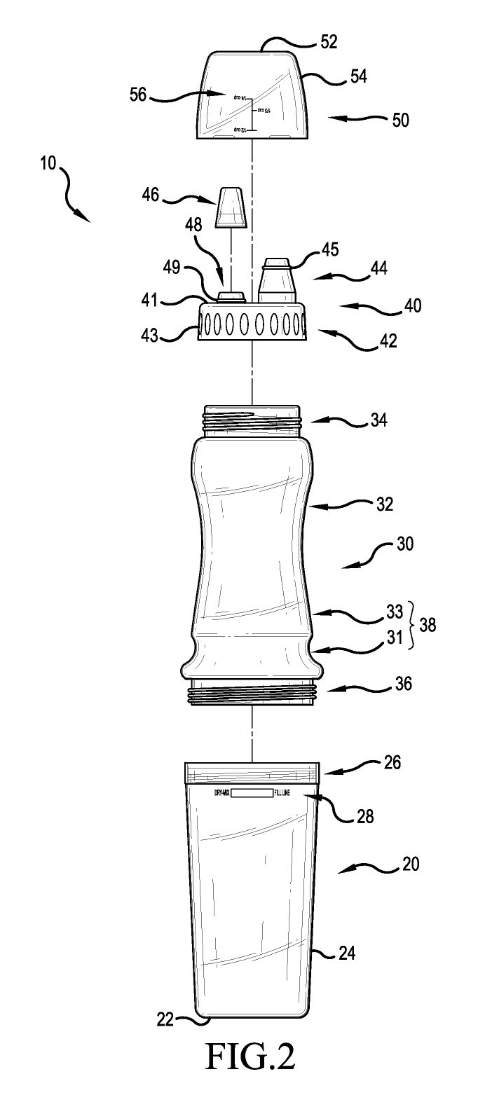

As shown in FIGS. 1 and 2, a batter dispenser 10 includes a lower body 20, an upper body 30, a dispensing member 40, and a cap 50. During storage of the batter dispenser 10, the lower body 20, the upper body 30, the dispensing member 40, and the cap 50 may be assembled together, as show in FIG. 1. Alternatively, the cap 50 can be inserted into the lower body 20 with the upper body 30 and dispensing member 40 attached to the cap 50, forming a nested arrangement that takes up less space.

The lower body 20 is a substantially cylindrical body defined by a bottom wall 22 and sidewall 24 extending upward from the bottom wall 24. The end of the lower body 20 opposite the bottom wall 24 is open. The upper portion of the sidewall 24 includes an internally formed threaded portion 26 that is configured to cooperate with upper body 30. The lower body 20 may be formed of a rigid plastic material using conventional polymer processing techniques.

While the exemplary embodiment shows a gradual increase in diameter of the sidewall 24 between the bottom wall 22 and the threaded portion 26, it is understood that the profile of the sidewall 24 can have a constant diameter or a variable diameter. In addition, the lower body 20 is not limited to substantially cylindrical shapes; however, it may be beneficial to select shapes that do not have sharp corners to ensure better mixing and more even flow of the batter.

The lower body 20 is configured to receive or hold dry-mix ingredients of a batter that is to be formed in the batter dispenser 10. Therefore, the lower body 20 may be semi-transparent or completely transparent to more easily identify the amount of dry-mix ingredients in the lower body 20. In addition, the lower body 20 may also include indicia 28 indicating a particular dry-mix fill line.

The upper body 30 is a substantially tubular body having two open ends, the upper body being defined by a sidewall 32. Both the upper portion and lower portion of the sidewall 32 include externally formed threaded portions 34 and 36, respectively. The lower threaded portion 36 is configured to cooperate with the threaded portion 26 of the lower body 20 to connect the upper body 30 to the lower body 20. The upper body 30 is formed of a plastic material using conventional polymer processing techniques.

The diameter of the sidewall 32 may vary between the lower threaded portion 36 and the upper threaded portion 34. In particular, the profile of the sidewall 32 may include a first neck portion 31 and a second neck portion 33, which, in combination, provides a suitable gripping portion 38. It should be understood that the upper body 30 is not limited to substantially tubular shapes; however, it may be beneficial to select shapes that avoid sharp corners to ensure better mixing and more even flow of the batter.

The upper body 30 may also be formed to be semi-transparent or transparent to allow a user to easily identify how much batter remains in the batter dispenser 10 and whether adequate mixing of the dry-mix ingredients and the other ingredients of the batter has occurred. In addition, the upper body 30 may be formed to be more flexible than the lower body 20 to allow the batter to be squeezed from the batter dispenser 10.

The dispensing member 40 includes a base 42 defined by an upper wall 41 and a substantially cylindrical sidewall 43 extending downward from the upper wall 41. The sidewall 43 includes an internally formed threaded portion (not shown) that cooperates with the upper threaded portion 34 of the upper body 30 to connect the dispensing member 40 to the upper body 30. A first nozzle 44 extends upward from the upper wall 41 away from the sidewall 43.

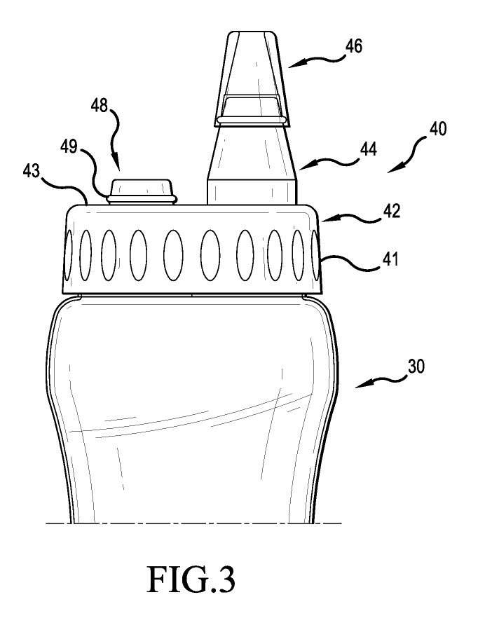

The first nozzle 44 has a frustoconical shape and is configured to provide a controlled flow of batter from the batter dispenser when pressure is applied to the upper body 30 (e.g., when the upper body 30 is squeezed). A ring-shaped projection 45 is provided on the outside of the first nozzle 44 to hold a second nozzle 46 (best seen in FIG. 3).

The second nozzle 46 is detachably secured to the first nozzle 44 to modify the flow of batter from the first nozzle 44 to achieve a different effect from that provided by the first nozzle 44. As such, the second nozzle 46 may be referred to as a detail nozzle because it provides a smaller, more controlled batter flow than the first nozzle 44. The second nozzle 46 can have variously shaped exit apertures, so that a variety of designs can be made. While the second nozzle 46 has a frustoconical shape so as to fit over the first nozzle 44, it is understood that the first and second nozzles 44, 46 do not have to be frustoconical shapes so long as the nozzles have similar shapes to allow for nesting of the nozzles.

A retainer 48 is provided to hold the second nozzle 46 when not in use, the retainer 48 extending upward from the base 42 away from the sidewall 43. A ring-shaped projection 49 is provided on the outside of the retainer 48 to detachably secure the second nozzle 46 to the retainer 48. Although not shown, a plurality of retainers 48 could be provided on top of the dispensing member 40, so that a plurality of different shaped or sized second nozzles can be secured.

The base 42 and the nozzles 44, 46 may be formed of plastic material using conventional polymer processing techniques. While the base 42 and first nozzle 44 are shown as being opaque and the second nozzle 46 is shown as being semi-transparent or transparent, it is understood that the transparency of these elements can be varied. The first and second nozzles 44, 46 may be made of nylon, which help controls the flow of batter and resists heat up to 450° F.

The cap 50 is detachably connected to the dispensing member 40 to protect the first and second nozzles 44, 46 and to close the batter dispenser 10 during storage and mixing of the batter. The cap 50 may also be in contact with the opening of the first nozzle 44 to seal the first nozzle 44 during mixing. The cap 50 includes a bottom wall 52 and a sidewall 54 extending upward from the bottom 52. The sidewall 54 is sized to fit over the base 42 of the dispensing member 40 and to provide a pressure fit between the cap 50 and the sidewall 43 of the dispensing member 40.

The cap 50 may be formed of plastic using conventional polymer processing techniques. The cap 50 may be semi-transparent or transparent and can be used to measure an amount of any liquid ingredients that are required to be mixed with the dry-mix ingredients to provide a batter to be dispensed from the batter dispenser 10. To this end, indicia 56 may be provided on the cap 50 to mark various liquid volumes.

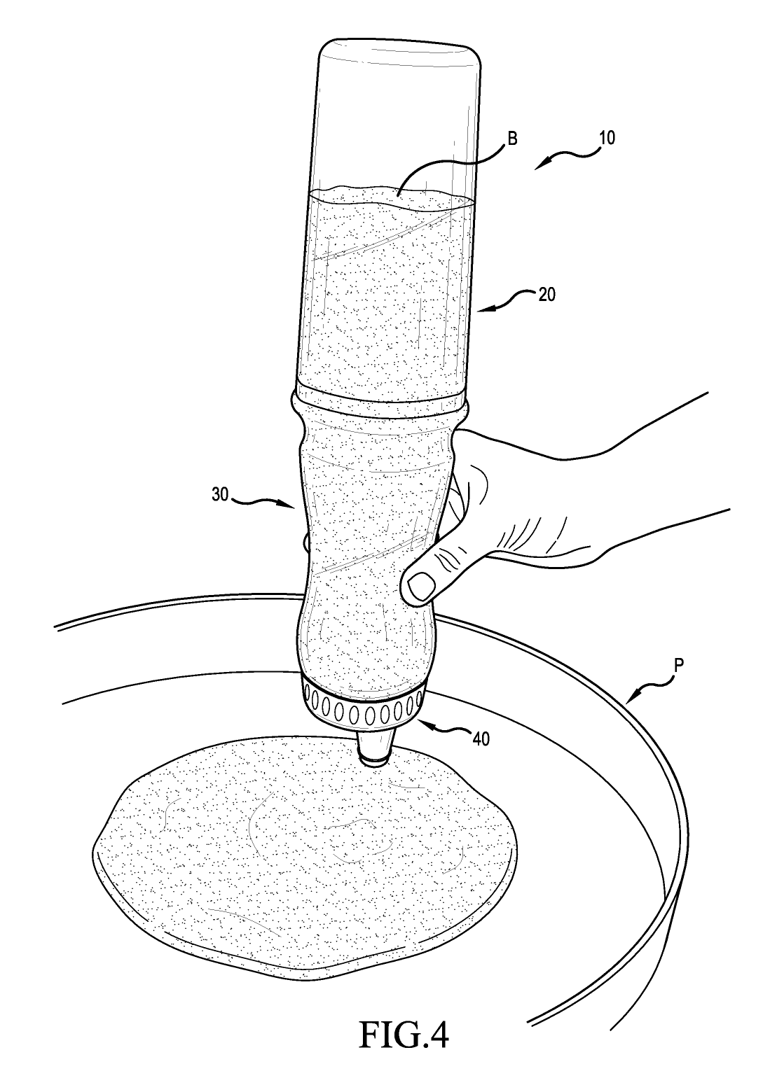

The batter dispenser 10 can be used to measure, mix, and dispense a batter for creation of one or more unique custom designed pancake, waffle, or other similar edible food products. That is, based on the multiple nozzles 44, 46 a user can make creative shapes or designs when dispensing the batter into or onto an appropriate cooking device, such as, for example, a griddle, pan, waffle iron, or the like. For example, as shown in FIG. 4, the batter dispenser 10 is being used to dispense batter B into a pan P for cooking While not shown, the batter B can be dispensed into different molds for providing different shapes, into a waffle iron, or into other cooking appliances. In addition, the batter dispenser 10 is configured to provide a single utensil for forming the batter B and dispensing the batter B without the need for separate mixing bowls and dispensers. One exemplary method of measuring, mixing, and dispensing of batter B using the batter dispenser 10 is set forth below.

Generally, a user will follow a recipe for making batter for pancakes, waffles, or other food products that require batter. The recipe calls for various ingredients in the form of dry-mix ingredient(s), one or more liquid ingredient(s), and any other ingredient(s) specifically called for by the recipe. Once these various ingredients are gathered, a user may place the dry-mix ingredient(s) into the lower body 20, either directly or through the open end of the upper body 30, if attached to the lower body 20. The indicia 28 indicating the recommended amount of the dry-mix ingredient(s) may be used to assist in providing the proper amount of the dry-mix ingredient(s).

Any liquid ingredient(s) may be measured using the indicia 56 on the cap 50 and added into the lower body 20. Depending on the volumes of the dry-mix ingredient(s) and the liquid ingredient(s), it may be necessary that the upper body 30 be attached to the lower body 20 prior to adding the liquid ingredient(s). Finally, any remaining ingredient(s) specifically called for by the recipe can be added at this time.

After all of the batter ingredients have been added into the batter dispenser 10, the dispensing member 40 and cap 50 are secured to the upper body 30. The batter dispenser 10 may then be shaken to mix the batter ingredients. After the batter is sufficiently mixed, the cap 50 is removed and the batter dispenser 10 is ready to dispense the batter into or onto the appropriate cooking device. The user can choose whether to use the first nozzle 44, which provides a relatively larger batter flow, or the second nozzle 46 attached to the first nozzle 44, which provides a relatively smaller batter flow.

The user simply squeezes the batter dispenser 10 at the upper body 30 to cause batter to be dispensed through nozzle(s) 44, 46. As described above, the most natural location to squeeze and grip the batter dispenser 10 is at the gripping portion 38.

Using the above method, the batter dispenser 10 can be used to measure, mix, and dispense the batter B without the need for separate mixing bowls and dispensers. In addition, the different nozzles 44, 46 can be used to created pancakes, waffles, or similar food products having unique shapes or designs.

The invention thus being described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A batter dispenser comprising:
a lower body;
an upper body detachably connected to the lower body; and
a dispenser member detachably connected to the upper body, the dispenser member including a first nozzle configured to control the flow of batter therethrough.

2. The batter dispenser of claim 1, wherein the upper body is more flexible than the lower body.

3. The batter dispenser of claim 2, wherein the lower body includes a bottom wall and a sidewall extending from the bottom wall.

4. The batter dispenser of claim 3, wherein the upper body includes a threaded portion, the sidewall includes a threaded portion at an end of the sidewall opposite the bottom wall, and the threaded portion of the upper body cooperates with the threaded portion of the sidewall to connect the upper body to the lower body.

5. The batter dispenser of claim 4, wherein the sidewall includes indicia indicating a fill line for the lower body.

6. The batter dispenser of claim 3, wherein the lower body is substantially cylindrical.

7. The batter dispenser of claim 2, wherein the upper body includes a sidewall defining two open ends, one of the two open ends being detachably connected to the lower body, and the other of the two open ends being detachably connected to the dispenser member.

8. The batter dispenser of claim 7, where at least one of the two open ends includes a threaded portion.

9. The batter dispenser of claim 8, wherein both of the two open ends include threaded portions.

10. The batter dispenser of claim 2, wherein the dispenser member includes a second nozzle configured to be detachably connected to the first nozzle, the second nozzle providing a different flowing rate compared to the first nozzle.

11. The batter dispenser of claim 10, wherein the dispenser member includes a base having the first nozzle and a retainer configured to hold the second nozzle when the second nozzle is not connected to the first nozzle.

12. The batter dispenser of claim 11, wherein the retainer includes a ring-shaped projection configured to detachably secure the second nozzle to the retainer.

13. The batter dispenser of claim 10, wherein the first nozzle has a frustoconical shape.

14. The batter dispenser of claim 13, wherein the first nozzle includes a ring-shaped projection configured to detachably secure the second nozzle to the first nozzle.

15. The batter dispenser of claim 1, further comprising a cap configured to be detachably connected to the dispenser member to close the batter dispenser.

16. The batter dispenser of claim 16, wherein the cap includes a base and a sidewall extending from the base, the sidewall including indicia indicated one or more fluid volumes.

17. A method of using a batter dispenser having a lower body, an upper body detachably connected to the lower body, and a dispenser member detachably connected to the upper body, the dispenser member including a first nozzle configured to control the flow of batter therethrough, the method including:
placing a dry-mix ingredient of a batter into the lower body;
adding a liquid ingredient of the batter to the dry-mix ingredients;
assembling the batter dispenser by connecting the lower body, the upper body, and the dispensing member;
shaking the batter dispenser to mix the dry-mix ingredient and the liquid ingredient to form the batter; and
squeezing the upper body to cause batter to flow out of the batter dispenser.

18. The method according to claim 17, wherein the batter dispenser includes a cap with indicia for measuring liquid volumes,
wherein adding the liquid ingredient includes measuring the liquid ingredient in the cap, and
wherein assembling the batter dispenser includes connecting the cap to the dispensing member prior to shaking the batter dispenser.

19. The method according to claim 17, wherein the dispensing member includes a retainer and a second nozzle configured to be detachably connected to the first nozzle and the retainer,
wherein assembling the batter dispenser includes removing the second nozzle from the retainer and connecting the second nozzle to the first nozzle, and
wherein squeezing the upper body causes the batter to flow out of the second nozzle connected to the second nozzle.
